(19) United States
(12) Patent Application Publication
(10) Pub. No.: US 2020/0079241 A1
(43) Pub. Date: Mar. 12, 2020

(54) ACCUMULATOR ARRANGEMENT

(71) Applicant: Mahle International GmbH, Stuttgart (DE)

(72) Inventors: Ingo Haeusler, Esslingen (DE); Thomas Kalmbach, Stuttgart (DE); Ruediger Knauss, Kernen i.R. (DE); Peter Nowak, Stuttgart (DE); Karl-Ulrich Schmid-Walderich, Tuebingen (DE)

(21) Appl. No.: 16/568,222

(22) Filed: Sep. 11, 2019

(30) Foreign Application Priority Data
Sep. 12, 2018 (DE) 10 2018 215 544.5

(51) Int. Cl. B60L 58/26; H01M 10/625; H01M 10/613; H01M 10/6568; H01M 10/6557; B60L 50/60

(52) U.S. Cl. CPC B60L 58/26; H01M 10/625; H01M 10/613; H01M 2220/20; H01M 10/6557; B60L 50/66; H01M 10/6568

(57) ABSTRACT

An accumulator arrangement for a hybrid or electric vehicle may include at least two closed partial housings, a plurality of battery modules arranged in at least two battery rows, and a cooling device through which a cooling fluid is flowable. The cooling device may include at least one central fluid directing element arranged between adjacent battery rows of the at least two battery rows. The at least one central fluid directing element may include at least one of i) a return duct and ii) a forward flow duct. Each of the at least two battery rows may be arranged in a respective partial housing. The at least one central fluid directing element may be secured between adjacent partial housings. The at least one central fluid directing element may be structured in a modular manner and may have at least two fluid directing modules fluidically connected to one another.

### CROSS-REFERENCE TO RELATED APPLICATIONS

This applications claims priority to German Patent Application No. DE 10 2018 215 544.5, filed on Sep. 12, 2018, the contents of which are hereby incorporated by reference in its entirety.

### TECHNICAL FIELD

The invention relates to an accumulator arrangement for a hybrid or electric vehicle.

### BACKGROUND

Accumulator arrangements for hybrid or electric vehicles are already known from the prior art. Here, several battery cells are accommodated in battery modules and are arranged in a shared housing. The battery cells are temperature-controlled here, to maintain their function. In particular in the case of accumulator arrangements with a high power density and a required quick charging capacity, an efficient cooling is indispensable. An efficient cooling requires here a high volume flow of the coolant and thereby also correspondingly large line cross-sections in coolant lines. Owing to the installation space requirement, which is to be reduced, in addition the coolant lines must be integrated into the accumulator arrangement.

Usually, the battery cells in a battery module are cooled by cooling plates which are in a heat-transferring contact with the individual battery cells. Such an accumulator arrangement is known for example from DE 10 2016 114 216 A1. The cooling plates are flowed through by a coolant and, depending on the configuration of the cooling plates, are supplied with the coolant via central or decentralized coolant lines. The coolant lines must be guided in a complex manner and secured individually. Furthermore, connections, interfaces and sealing sites impede the mounting of the accumulator arrangement.

### SUMMARY

It is therefore the object of the invention to indicate for an accumulator arrangement of the generic type an improved or at least alternative embodiment, in which the described disadvantages are overcome.

This problem is solved according to the invention by the subject of the independent claim(s). Advantageous embodiments are the subject of the dependent claim(s).

A generic accumulator arrangement is provided for a hybrid or electric vehicle and has several battery modules, which are arranged in at least two battery rows. The accumulator arrangement has, in addition, a cooling device, able to be flowed through by a cooling fluid, with at least one central fluid directing element which is arranged between the respective adjacent battery rows. The respective central fluid directing element has a return duct for collecting the cooling fluid flowing off from the two battery rows and/or has a forward flow duct for distributing the cooling fluid flowing to the two battery rows. According to the invention, the respective battery rows are arranged in respectively a closed partial housing of the accumulator arrangement and the respective central fluid directing element is secured between the adjacent partial housings. Here, the respective central fluid directing element is constructed in a modular manner and has at least two fluid directing modules which are fluidically connected with one another.

In the accumulator arrangement according to the invention, the battery modules of the adjacent battery rows are supplied with the cooling fluid via the shared central fluid directing element, so that the construction of the accumulator arrangement is simplified. The cooling fluid is a liquid. The cooling fluid is preferably a dielectric liquid. The cooling fluid is preferably a dielectric coolant. The dielectric coolant is preferably oil or is based on oil. The central fluid directing element or respectively the individual fluid directing modules of the central fluid directing element can be made for example from plastic in an injection moulding method. Furthermore, the central fluid directing element is constructed in a modular manner, whereby the production of the central fluid directing element is simplified. In addition, differently configured central fluid directing elements can be constructed from the individual fluid directing modules. Both the return duct or the forward flow duct and also the return duct and the forward flow duct can be arranged in the central fluid directing element. The battery rows are arranged here in the respective partial housings, so that during the mounting of the accumulator arrangement the two partial housings are able to be secured to the central fluid directing element in a simplified manner, and the individual battery modules in the respective partial housings are able to be fluidically connected to the central fluid directing element in a simplified manner. Thereby, the mounting of the accumulator arrangement can be distinctly simplified.

In an advantageous configuration of the accumulator arrangement, provision is made that the respective battery module has a cooling unit which is able to be flowed through by the cooling fluid. Here, the respective cooling unit is secured to the respective battery module in a heat-transferring manner, and is connected fluidically to the central fluid directing element via a wall of the respective partial housing. Here, through-openings of the respective cooling unit can be fluidically connected with through-openings in the wall, so that the cooling fluid can flow through the wall into the respective cooling unit. Connecting sites around the respective fluidically connected through-openings can be expediently sealed towards the exterior. Accordingly, the central fluid directing element also has several through-openings, which can be fluidically connected with the through-openings in the wall of the respective partial housing. Here, also, connection sites around the respective through-openings can be sealed towards the exterior. The cooling unit can be, for example, a cooling plate able to be flowed through by the fluid, which cooling plate lies against the battery cells of the respective battery module in a heat-transferring manner. In the respective central fluid directing element, the forward flow duct and the return duct can be shaped here so that the cooling fluid can flow out from the forward flow duct into the respective cooling unit and can flow off out from the respective cooling unit into the return duct. Thereby, the construction of the accumulator arrangement can be distinctly simplified, because both the flowing in and also the flowing off of the cooling fluid into the adjacent partial housings can take place through the single central fluid directing element.

In an advantageous alternative configuration of the accumulator arrangement, provision is made that the respective battery module is arranged in an interior of the respective partial housing so as to be able to be flowed around directly by the cooling fluid. Here, the interior is fluidically connected with the central fluid directing element via a wall of the respective partial housing. Here, through-openings in the wall can be fluidically connected with through openings of the central fluid directing element, so that the cooling fluid can flow directly into the interior of the respective partial housing. Connection sites around the respective through openings which are fluidically connected with one another can be expediently sealed towards the exterior. In the interior, the cooling fluid can then flow directly around the respective battery module and the individual battery cells of the respective battery module, so that the battery cells can be cooled particularly effectively. The cooling fluid can be dielectric, in order to prevent a short-flow in the respective battery module. Advantageously in this configuration of the accumulator arrangement, provision can be made that the forward flow duct or the return duct are formed in the respective central fluid directing element. Thereby, the cooling fluid in the respective interior can be fed into the respective interior via the one central fluid directing element, or discharged, and via the other element—for example via the other central fluid directing element or via an individual fluid directing element described further below—can be discharged or fed in. Thereby, in the interior of the respective partial housing, the through-flow of the cooling fluid can be intensified and consequently the battery cells can be effectively cooled.

Advantageously, provision can be made that the cooling device has respectively an individual fluid directing element on both sides on the laterally arranged partial housings. The individual fluid directing element has here the forward flow duct, when the central fluid directing element, adjacent via the laterally arranged partial housing, has the individual return duct. Accordingly, the individual fluid directing element has the return duct when the central fluid directing element, adjacent via the laterally arranged partial housing, has the individual forward flow duct. The cooling fluid can then flow via the forward flow duct into the respective partial housing and can be directed into the respective cooling unit or directly into the respective interior of the partial housing. The cooling fluid can then flow via the respective cooling unit or directly via the respective interior and be subsequently directed into the respective return duct. In particular in the case of the direct flowing around of the battery modules, thereby the through-flow of the cooling fluid in the respective interior of the respective partial housing can be intensified and the respective battery module can be effectively cooled. The individual fluid directing element can differ from the central fluid directing element merely in that through the individual fluid directing element the cooling fluid is fed to the battery modules of the one partial housing or is discharged therefrom. Accordingly, the forward flow duct or the return duct of the individual fluid directing element are fluidically connected only with one of the partial housings. Otherwise, the construction of the individual fluid directing element can correspond to the construction of the central fluid directing element. In particular, the individual fluid directing element can be constructed in a modular manner and can be made for example from plastic in an injection moulding method.

Advantageously, provision can be made that a flow cross-section of the respective return duct and/or of the respective forward flow duct changes in the central fluid directing element. Thereby in particular the pressure change and the flow in the respective forward flow duct and/or in the respective return duct can be adapted and the cooling fluid can be fed uniformly to the individual battery modules in the respective partial housing or discharged therefrom. As a whole thereby the respective battery modules in the accumulator arrangement can be cooled identically and effectively irrespective of their position in the partial housing and in particular of their distance from a feed of the forward flow duct and/or from a discharge of the return duct in the central fluid directing element. The central fluid directing element can also have a rib structure which reinforces the central fluid directing element.

In a particularly advantageous configuration of the central fluid directing element, provision is made that the number of respective fluid directing modules in the respective central fluid directing element corresponds to the number of battery modules in the respective partial housing. In this way, the respective fluid directing module is respectively assigned to a battery module in the respective adjacent partial housing. In particular, thereby the configuration of the respective fluid directing module can be adapted to the position of the two battery modules to be supplied in the respective partial housings. In particular, the flow cross-section of the respective return duct and/or of the respective forward flow duct can be adapted to the distance of the two battery modules from a feed of the forward flow duct and/or from a discharge of the return duct in the central fluid directing element.

In an advantageous further development of the accumulator arrangement, provision is made that the respective fluid directing module has a first module half and a second module half. Here, the first module half is formed integrally on the one adjacent partial housing, and the second module half is formed integrally on the other adjacent partial housing. The respective module halves can be secured to one another towards the exterior in a fluid-tight manner and preferably in a materially bonded manner. Here, the respective module halves can be, for example, glued or welded to one another.

Advantageously, the fluid directing modules in the respective central fluid directing element and/or the respective central fluid directing element can be secured to the two partial housings in a materially bonded or form-fitting manner. The materially bonded connection is preferably an adhesive connection or a welded connection, and a form-fitting connection is preferably a tongue-and-groove connection or an outwardly sealed screw connection or an outwardly sealed rivet connection. Advantageously, the respective partial housings and the cooling device can be arranged in a two-part battery housing. In addition, the battery housing can be secured to a vehicle body and/or to a vehicle transverse strut—for example a seat strut—of the hybrid or electric vehicle for example by a screw connection. In addition, the respective central fluid directing element can have at least one securing unit, by which the respective central fluid directing element is secured through the battery housing and thereby the battery housing per se is secured to the vehicle body and/or to the vehicle transverse struct of the hybrid or electric vehicle for example by a screw connection. Furthermore, further components of the accumulator arrangement, such as for example one of the housing halves of the battery housing, can be secured to the central fluid directing element or also to the individual fluid directing element.

To sum up, the accumulator arrangement according to the invention has a reduced installation space requirement and a simplified construction. The modular central fluid directing element enables a variable construction of the cooling device and can direct the cooling fluid uniformly to the battery modules or respectively direct it from these. As a whole, thereby the cooling of the battery modules can be intensified in the accumulator arrangement according to the invention.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically

FIG. 1 shows a view of a partial housing with battery modules in an accumulator arrangement according to the invention;

FIGS. 2 to 4 show views of adjacent partial housings with a central fluid directing element in the battery arrangement according to the invention;

FIGS. 5 to 7 show views of a central fluid directing element in the accumulator arrangement according to the invention;

FIG. 8 shows a sectional view of the central fluid directing element in the accumulator arrangement according to the invention.

### DETAILED DESCRIPTION

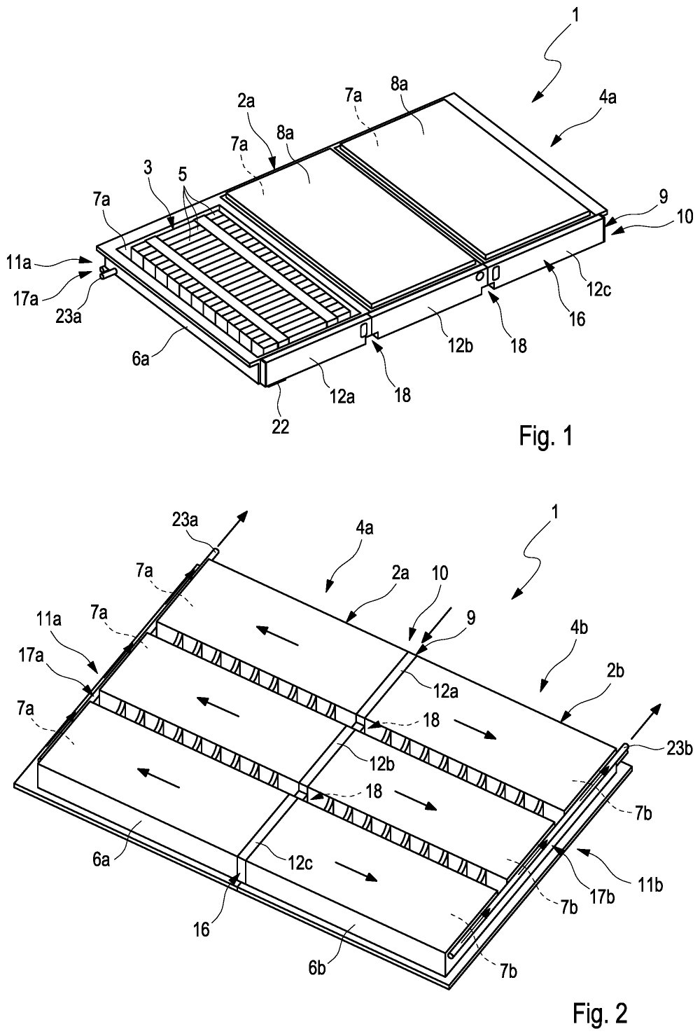

FIG. 1 shows a view of a partial housing 2a in an accumulator arrangement 1 according to the invention for a hybrid or electric vehicle. The accumulator arrangement 1 has several battery modules 3, wherein here three of these battery modules 3 are arranged to a battery row 4a. The respective battery modules 3 have several individual battery cells 5, which are stacked to the respective battery module 3 and electrically interconnected. The battery row 4a is arranged in the partial housing 2a, which in this example embodiment has a housing shell 6a with several interior spaces 7a. The respective interior spaces 7a are tightly closed towards the exterior by respectively a cover 8a. The respective battery module 3 is secured here in the respective interior space 7a of the partial housing 2a so as to be able to be flowed through by a cooling fluid. The cooling fluid can be dielectric here, in order to prevent a short-flow into the battery modules 3.

A central fluid directing element 9 of a cooling device 10 of the accumulator arrangement 1, able to be flowed through by the cooling fluid, is secured to the partial housing 2a on one side. The cooling fluid can flow through the central fluid directing element 9 into the individual interior spaces 7a in the partial housing 2a and can flow out via an individual fluid directing element 11a out from the individual interior spaces 7a of the partial housing 2a. For this, a feed 22 and a forward flow duct 16 are provided in the central fluid directing element 9. In the individual fluid directing element 11a accordingly a discharge 23a and a return duct 17a are provided. In this example embodiment, the individual fluid directing element 11a is formed in the housing shell 6a of the partial housing 2a. The central fluid directing element 9 is constructed here in a modular manner from a total of three fluid directing modules 12a, 12b and 12c, which are secured to one another in a form-fitting manner by a tongue-and-groove connection 18. The central fluid directing element 9 and the partial housing 2a can be made for example from plastic.

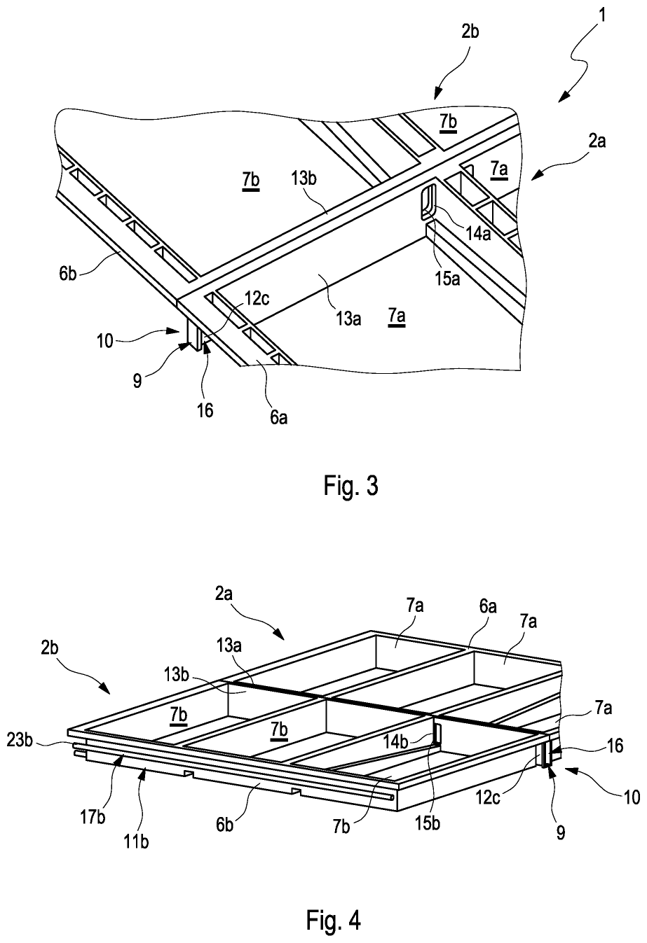

In FIG. 2 the accumulator arrangement 1 is shown rotated. The accumulator arrangement 1 has here the partial housing 2a and an identical partial housing 2b for a second battery row 4b. Between the adjacent partial housings 2a and 2b, the central fluid directing element 9 of the cooling device 10 is arranged, which feeds the cooling fluid into the partial housings 2a and 2b. On a housing shell 6b of the partial housing 2b, a further individual fluid directing element 11b with a return duct 17b and with a discharge 23b is formed, via which the cooling fluid can flow out from interior spaces 7b of the partial housing 2b. In the interior spaces 7b, the battery modules 3 of the battery row 4b are arranged so as to be able to be flowed through by the cooling fluid. As indicated by arrows, the cooling fluid flows into the forward flow duct 16 of the central fluid directing element 9 and is directed into the individual interior spaces 7a and 7b. The cooling fluid flows through the interior spaces 7a and 7b to the return ducts 17a and 17b of the individual fluid directing elements 11a and 11b, and the battery cells 5 in the battery modules 3 are flowed around directly by the cooling fluid and are thereby cooled. Finally, the cooling fluid flows via the discharges 13a and 13b out from the accumulator arrangement 1.

FIG. 3 and FIG. 4 show views of the adjacent partial housings 2a and 2b. The respective interior spaces 7a and 7b are fluidically connected with the central fluid directing element 9 via walls 13a and 13b of the respective partial housings 2a and 2b. Here, through-openings 14a and 14b are arranged in the walls 13a and 13b at through-openings 15a and 15b of the central fluid directing element 9, so that the cooling fluid can flow directly out from the central fluid directing element 9 into the interior spaces 7a and 7b of the respective partial housings 2a and 2b. Expediently, the central fluid directing element 9 is secured to the two partial housings 2a and 2b in a materially bonded or form-fitting manner and in a fluid-tight manner towards the exterior.

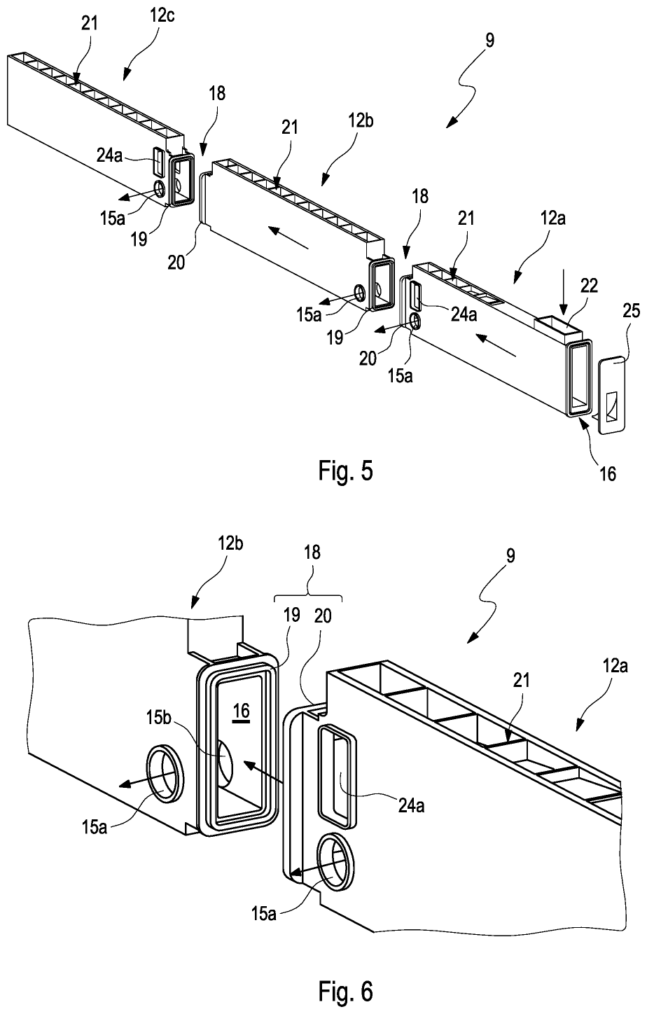

FIG. 5 to FIG. 7 show views of the central fluid directing element 9. The central fluid directing element 9 is constructed in a modular manner from the fluid directing modules 12a, 12b and 12c, which in this example embodiment are secured to one another in a fluid-tight manner by the tongue-and-groove connection 18. Laterally, the central fluid directing element 9 is closed in a fluid-tight manner by a closing cover 25. The tongue-and-groove connection 18 is formed here respectively by a tongue 19 and a groove 20, which engage into one another around the forward flow duct 16 and seal the latter towards the exterior. The central fluid directing element 9 has the through-flow openings 15a and 15b, which fluidically connect the forward flow duct 16 with the interior spaces 7a and 7b of the two partial housings 2a and 2b. Outside the forward flow duct 16, the central fluid directing element 9 has a rib structure 21 with several ribs, by which the central fluid directing element 9 is reinforced. Within the forward flow duct 16, in addition line openings 24a and 24b are formed in the central fluid directing element 9. Through the line openings 24a and 24b, lines carrying current can be guided into the interior spaces 7a and 7b and the battery modules 3 can be electrically interconnected with one another. The flow of the cooling fluid in the central fluid directing element 9 is indicated by arrows.

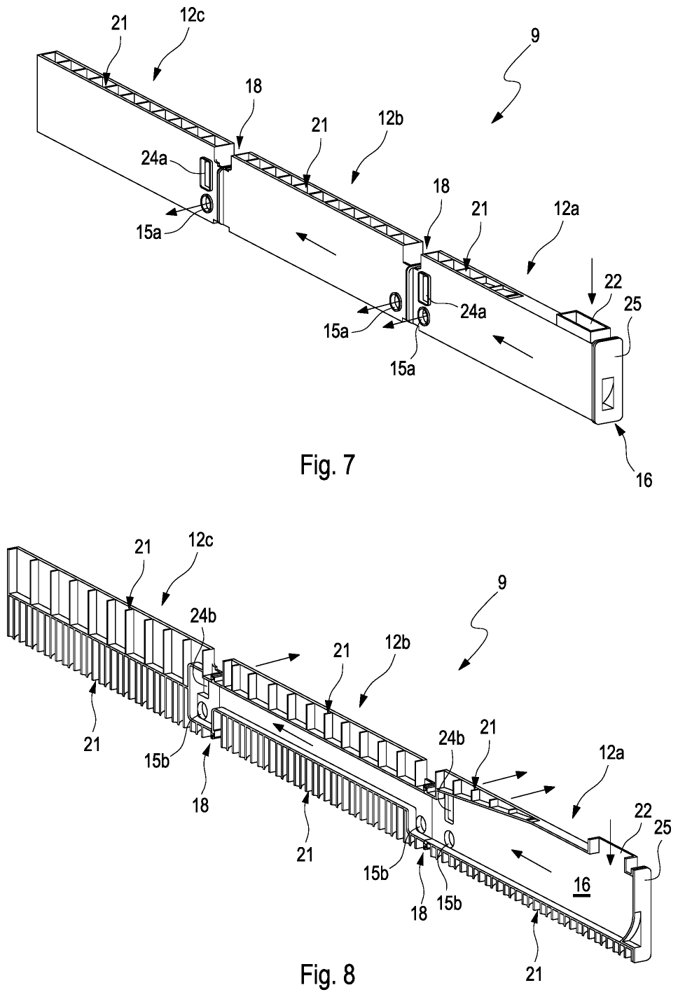

FIG. 8 shows a sectional view of the central fluid directing element 9, which is constructed in a modular manner. As can be seen here, a flow cross-section of the forward flow duct 16 changes in the central fluid directing element 9. Here, the flow cross-section decreases away from the feed 22. For this, the fluid directing modules 12a, 12b and 12c are configured differently from their arrangement in the central fluid directing element 9. In this advantageous manner, the flow and the pressure progression can be adapted in the forward flow duct 16. Furthermore, the cooling fluid can be fed uniformly to the individual battery modules 3 in the partial housings 2a and 2b. In addition, the volume flow in the respective interior spaces 7a and 7b is ideally identical, irrespective of their distance from the feed 22 of the central fluid directing element 9. The flow of the cooling fluid in the central fluid directing element 9 is indicated by arrows.

To sum up, the accumulator arrangement 1 according to the invention has a reduced installation space requirement and a simplified construction. The modular central fluid directing element 9 enables in addition a variable construction of the cooling device 10. The cooling fluid can be directed uniformly through the central fluid directing element 9 to the battery modules 3 and thereby the cooling of the battery modules 3 can be intensified.

1. An accumulator arrangement for a hybrid or electric vehicle, comprising:
a plurality of battery modules arranged in at least two battery rows;
a cooling device through which a cooling fluid is flowable, the cooling device including at least one central fluid directing element arranged between adjacent battery rows of the at least two battery rows;
the at least one central fluid directing element including at least one of i) a return duct for collecting the cooling fluid flowing off from the at least two battery rows and ii) a forward flow duct for distributing the cooling fluid to the at least two battery rows;
at least two closed partial housings, each of the at least two battery rows arranged in a respective partial housing of the at least two partial housings and the at least one central fluid directing element secured between adjacent partial housings of the at least two partial housings; and
wherein the at least one central fluid directing element is structured in a modular manner and has at least two fluid directing modules fluidically connected to one another.

2. The accumulator arrangement according to claim 1, wherein at least one of:
each battery module of the plurality of battery modules includes a respective cooling unit through which the cooling fluid is flowable, and wherein the respective cooling unit is secured to the respective battery module in a heat-transferring manner and is fluidically connected with the at least one central fluid directing element via a wall of the respective partial housing in which the respective battery module is arranged; and
each battery module of the plurality of battery modules is arranged in an interior space of the respective partial housing such that the cooling fluid is flowable directly around the respective battery module, and wherein the interior space is fluidically connected with the at least one central fluid directing element via a wall of the respective partial housing.

3. The accumulator arrangement according to claim 1, wherein:
the cooling device further includes at least two individual fluid directing elements arranged on opposing lateral sides of the adjacent partial housings; and
the at least two individual fluid directing elements each include i) a forward flow duct for distributing cooling fluid to the at least two battery rows when the at least one central fluid directing element includes the return duct and ii) a return duct for collecting cooling fluid flowing off from the at least two battery rows when the at least one central fluid directing element includes the forward flow duct.

4. The accumulator arrangement according to claim 1, wherein a flow cross-section of the at least one of i) the return duct and ii) the forward flow duct varies in the at least one central fluid directing element.

5. The accumulator arrangement according to claim 1, wherein the at least one central fluid directing element includes a rib structure reinforcing the at least one central fluid directing element.

6. The accumulator arrangement according to claim 1, wherein the at least two fluid directing modules includes a number of fluid directing modules corresponding to a number of the plurality of battery modules arranged in each of the at least two partial housings.

7. The accumulator arrangement according to claim 1, wherein the at least two fluid directing modules are secured to one another in at least one of a materially bonded manner and a form-fitting manner.

8. The accumulator arrangement according to claim 1, wherein the at least one central fluid directing element is secured to the adjacent partial housings in at least one of a materially bonded manner and a form-fitting manner.

9. The accumulator arrangement according to claim 1, wherein at least one of the at least two fluid directing modules includes a first module half and a second module half, the first module half integrally arranged on one of the adjacent partial housings and the second module half integrally arranged on the other of the adjacent partial housings, and wherein the first module half and the second module half are secured to one another in a fluid-tight manner towards an exterior.

10. The accumulator arrangement according to claim 1, wherein:
the at least two partial housings and the cooling device are arranged in a two-part battery housing; and
the two-part battery housing is secured to at least one of a vehicle body and a vehicle transverse strut of the hybrid or electric vehicle.

11. The accumulator arrangement according to claim 10, wherein the at least one central fluid directing element includes at least one securing unit via which the at least one central fluid directing element is secured, through the two-part battery housing, to at least one of the vehicle body and the vehicle transverse strut.

12. The accumulator arrangement according to claim 1, wherein the at least two fluid directing modules are secured to one another in a form-fitting manner via a tongue-and-groove connection.

13. The accumulator arrangement according to claim 1, wherein the at least two fluid directing modules are secured to one another in a material bonded manner via an adhesive connection.

14. The accumulator arrangement according to claim 1, wherein the at least one central fluid directing element is structured such that the cooling fluid is flowable therethrough.

15. An accumulator arrangement for a hybrid or electric vehicle, comprising:
a plurality of battery modules arranged in a plurality of battery rows;
a plurality of closed partial housings, each of the plurality of battery rows arranged in a respective partial housing of the plurality of partial housings;
a cooling device through which a cooling fluid is flowable, the cooling device including at least one central fluid directing element arranged between adjacent partial housings of the plurality of partial housings;
the at least one central fluid directing element including a return duct for collecting the cooling fluid flowing off from the plurality of battery rows; and
wherein the at least one central fluid directing element is structured in a modular manner and includes a plurality of fluid directing modules fluidically connected to one another.

16. The accumulator arrangement according to claim 15, wherein:
each battery module of the plurality of battery modules includes a respective cooling unit through which the cooling fluid is flowable; and
the respective cooling unit is secured to the respective battery module in a heat-transferring manner and is fluidically connected with the at least one central fluid directing element via a wall of the respective partial housing in which the respective battery module is arranged.

17. The accumulator arrangement according to claim 15, wherein:
each battery module of the plurality of battery modules is arranged in an interior space of the respective partial housing such that the cooling fluid is flowable directly around the respective battery module; and
the interior space is fluidically connected with the at least one central fluid directing element via a wall of the respective partial housing.

18. An accumulator arrangement for a hybrid or electric vehicle, comprising:
a plurality of battery modules arranged in a plurality of battery rows;
a plurality of closed partial housings, each of the plurality of battery rows arranged in a respective partial housing of the plurality of partial housings;
a cooling device through which a cooling fluid is flowable, the cooling device including at least one central fluid directing element arranged between adjacent partial housings of the plurality of partial housings;
the at least one central fluid directing element including a forward flow duct for distributing the cooling fluid to the plurality of battery rows; and
wherein the at least one central fluid directing element is structured in a modular manner and includes a plurality of fluid directing modules fluidically connected to one another.

19. The accumulator arrangement according to claim 18, wherein a number of the plurality of fluid directing modules corresponds to a number of the plurality of battery modules arranged in each of the plurality of partial housings.

20. The accumulator arrangement according to claim 18, wherein:
one of the adjacent partial housings includes a first module half and the other of the adjacent partial housings includes a second module half; and
the first module half and the second module half are coupled to one another in a fluid-tight manner forming a fluid directing module of the plurality of fluid directing modules.
